(19) United States
(12) Patent Application Publication
(10) Pub. No.: US 2021/0392188 A1
(43) Pub. Date: Dec. 16, 2021

(54) INFORMATION PROCESSING METHOD, AND PROGRAM

(71) Applicant: THK CO., LTD., Tokyo (JP)

(72) Inventors: Shuhei Yamanaka, Minato-ku, Tokyo (JP); Masatomo Tokuno, Minato-ku, Tokyo (JP)

(73) Assignee: THK CO., LTD., Tokyo (JP)

(21) Appl. No.: 17/284,876

(22) PCT Filed: Oct. 15, 2019
(86) PCT No.: PCT/JP2019/040497

§ 371 Date: Apr. 13, 2021

(30) Foreign Application Priority Data
Oct. 17, 2018 (JP) 2018-195852

(51) Int. Cl. H04L 29/08; H04W 4/80; G08C 17/02

(52) U.S. Cl. CPC H04L 67/12; G08C 2200/00; G08C 17/02; H04W 4/80

(57) ABSTRACT

All information processing apparatus executes: a reception step of receiving sensor data transmitted from a sensor device via near-field wireless communication; a transmission step of transmitting the received sensor data to a server apparatus; and an output step of acquiring sensor data specified by a user from the server apparatus and providing the sensor data to the user; and, at the output step, a web browser operating on the information processing apparatus is used as an output interface.

### TECHNICAL FIELD

The present invention relates to a technique for providing data obtained by a device such as a sensor to a user.

### BACKGROUND ART

A technology called a sensor network has been considered. This enables collection, management and seamless utilization of sensing data by installing sensor devices having a sensing function and a communication function in various places, mobile bodies, industrial facilities and the like and networking the sensor devices. As a technique related to the technology, a sensor amplifier that amplifies and processes a signal detected by a sensor and wirelessly transmits the signal to an external apparatus is known.

### CITATION LIST

### Patent Literature

Patent Literature 1: Japanese Patent Laid-Open No. 2015-02692

### SUMMARY OF INVENTION

### Technical Problem

Generally, data collected by a sensor (sensor data) is transmitted to a server apparatus in which the sensor data is accumulated, and is distributed in response to a user request. In such a form, however, it is necessary to introduce dedicated equipment (hardware and software) for performing communication with the server apparatus on the user side that receives distribution of the sensor data, and initial cost is required.

The present invention has been made in view of the above situation, and an object is to provide an environment for using sensor data at a low cost.

### Solution to Problem

In an information processing method according to the present invention, an information processing apparatus executes: a reception step of receiving sensor data transmitted from a sensor device via near-field wireless communication; a transmission step of transmitting the received sensor data to a server apparatus; and an output step of acquiring sensor data specified by a user from the server apparatus and providing the sensor data to the user; and, at the output step, a web browser operating on the information processing apparatus is used as an output interface.

The information processing apparatus may be a general-purpose computer (a personal computer or a mobile type computer including a smartphone, or the like). The reception step and the transmission step may be executed by dedicated application software operating on the information processing apparatus (for example, a native application) or may be executed by general-purpose application software operating on the information processing apparatus (for example, a web browser or the like).

In the information processing method according to the present invention, a web browser operating on the information processing apparatus is used as an input interface for providing sensor data to a user. According to such a configuration, necessity of constructing a dedicated environment for displaying the sensor data is eliminated, and it is possible to reduce introduction cost.

Further, the reception step may be executed by an external program operating on the web browser; and the received sensor data may be stored into a memory area assigned to the web browser.

Further, at the transmission step, the sensor data stored in the memory area may be transmitted to the server apparatus.

By executing the reception step using the external program operating on the web browser, the necessity of constructing a dedicated environment is also eliminated in reception of sensor data. The reception step can be executed, for example, via an API for wireless communication that can be accessed by JavaScript (registered trademark).

Further, the external program may cause the information processing apparatus to receive the sensor data via a wireless communication API that is not dependent on an architecture of the information processing apparatus.

Further, the external program may cause the information processing apparatus to receive the sensor data via a Web Bluetooth API.

According to such a configuration, any platform that is implemented with a wireless communication API makes it possible to access sensor data regardless of the architecture of hardware and the kind of an operating system.

Further, the external program may be stored in the server apparatus.

According to such a configuration, any environment that enables connection to a network and use of a web browser makes it possible to acquire sensor data.

Further, the information processing apparatus may be a mobile terminal.

A program according to the present invention is a program executed by a web browser operating on an information processing apparatus; and the program executes: a reception step of receiving sensor data transmitted from a sensor device via near-field wireless communication; a transmission step of transmitting the received sensor data to a server apparatus; and an output step of acquiring sensor data specified by a user from the server apparatus and providing the sensor data to the user.

Note that the present invention can be identified as an information processing method that includes at least a part of the above steps. Further, the present invention can also be identified as a program that executes at least a part of the above steps. The above processes can be freely combined and implemented as far as a technical contradiction does not occur.

The “sensor device” in the present invention means any apparatus that outputs (provides) some data, and a sensor, an actuator, a controller, a computer, a home appliance, a wearable terminal and the like can be given as examples. Especially, the present invention can be preferably applied to a system that acquires sensing data outputted from a sensor.

### Advantageous Effects of Invention

According to the present invention, it is possible to provide an environment for using sensor data at a low cost.

### BRIEF DESCRIPTION OF DRAWINGS

FIG. 1 is a configuration diagram of a sensor data collection system according to an embodiment.

FIG. 2 is a diagram illustrating a flow of data that the sensor data collection system handles.

FIG. 3 illustrates an example of sensor data generated by a sensor amplifier.

FIG. 4 is a flowchart of a process performed by the sensor data collection system according to the embodiment.

FIG. 5 is a flowchart of a process performed by the sensor data collection system according to the embodiment.

### DESCRIPTION OF EMBODIMENT

A preferred embodiment of the present invention will be described below with reference to drawings. Description of each component below should be appropriately changed according to a configuration of a system to which the invention is applied and various kinds of conditions and is not intended to limit the scope of the invention to the description below.

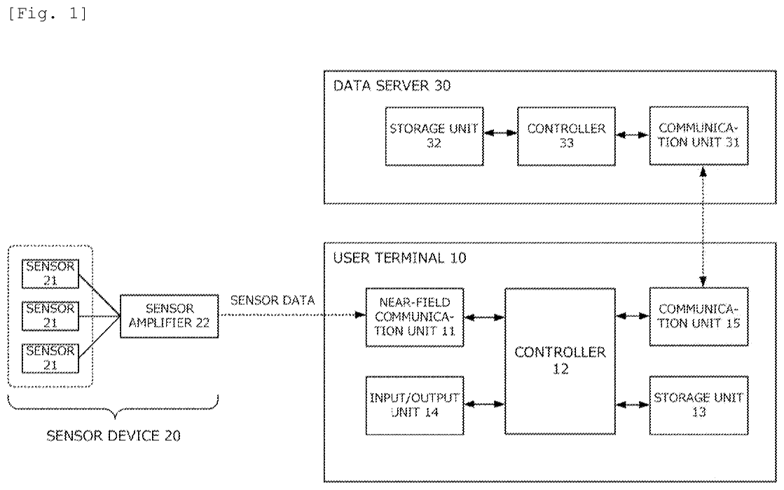

An overall configuration of a sensor data collection system according to a first embodiment will be described with reference to FIG. 1. This sensor data collection system is configured including a sensor device 20 that collects measured values from a plurality of sensors and outputs the measured values as sensor data, a user terminal 10 which is a computer that uses the sensor data, and a data server 30 in which the sensor data is accumulated. The sensor device 20 is configured with a plurality of sensors 21 and a sensor amplifier 22 which is a device that manages the sensors 21.

Although one sensor device 20 and one user terminal 10 are illustrated in this example, there may be a plurality of sensor devices 20 and user terminals 10.

The sensor device 20 and the user terminal 10 are communicably connected, for example, by a near-field wireless communication standard, for example, Bluetooth (registered trademark) or the like. Farther, the user terminal 10 and the data server 30 are communicably connected by a wide-area network such as the Internet or a LAN. Note that the network is not limited to a single network, and a network in any form may be used if transmission/reception of sensor data can be realized.

Each sensor 21 is a device that detects and outputs a physical quantity of a sensing target and a change in the physical quantity.

As a typical example of the sensor 21, a position sensor, a temperature sensor, a humidity sensor, an illuminance sensor, a pressure sensor, a load sensor, a sound sensor, an infrared sensor, an attitude sensor, a rainfall sensor, a radiation sensor, a gas sensor, an acceleration sensor, a gyroscope, a GPS sensor and the like can be given. Further, since each piece of equipment such as a mobile phone, a smartphone, a tablet terminal, a mobile PC and a drone is equipped with various kinds of sensors, these pieces of equipment can be treated as sensors. Further, many sensors have already been installed in all places in the world for various uses and purposes such as FA and production management of factories, urban traffic control, measurement of environments such as weather, health care and crime prevention, and it is possible to connect these sensors to the present system. Note that a plurality of kinds of sensors may be mixed.

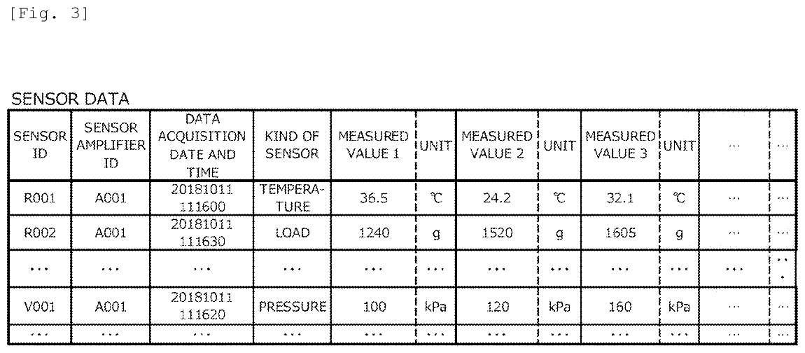

The sensor amplifier 22 is a device that wiredly or wirelessly communicates with one or more sensors 21 to perform management of the sensors 21, acquisition of measured values from the sensors 21 and the like. The sensor amplifier 22 may perform predetermined processing (for example, signal processing such as noise removal, arithmetic operation such as average processing, sampling, data compression, time stamp attachment and the like) for the measured values. Further, the sensor amplifier 22 may execute a function of generating sensor data in a common format based on the measured values acquired from the sensors 21. FIG. 3 is a diagram illustrating sensor data generated by the sensor amplifier 22 and transmitted to the user terminal 10. The sensor amplifier 22 has a function of performing near-field wireless communication with the user terminal 10 and transmitting sensor data, with a request from the user terminal 10 as a trigger.

Equipment such as a smartphone, a tablet terminal, a mobile PC, a drone and a wearable terminal internally includes sensors such as an image sensor, a GPS sensor, an acceleration sensor and a microphone and has a function of processing and outputting data obtained by each sensor and a network communication function. Therefore, each of these pieces of equipment can be regarded as a device in which the sensors 21 and the sensor amplifier 22 are integrated (the sensor device 20).

The user terminal 10 is a computer that uses sensor data outputted by the sensor device 20. The user terminal 10 can be configured with a general-purpose computer provided with a CPU (a processor), a memory, an auxiliary memory (such as an HDD), a communication device, and input device, a display device and the like. Various kinds of functions of the user terminal 10 described later are realized by the CPU executing a necessary program.

The user terminal 10 is configured to be capable of executing a first process of receiving sensor data outputted by the sensor device 20 and transmitting the sensor data to the data server 30 described later (a reception step and a transmission step in the present invention) and a second process of acquiring sensor data stored in the data server 30 and providing the sensor data to a user (an output step in the present invention).

Note that, in the second process, the sensor data may be outputted by numerical values or may be visualized in such a format that the user can easily visually confirm the sensor data and outputted. Furthermore, the outputted sensor data may be transferred to an external application program that provides various kinds of services.

The data server 30 is a server apparatus in which sensor data collected by the user terminal 10 is accumulated. In the present embodiment, the sensor data collected by the user terminal 10 is transmitted to the data server 30 and is transmitted to the user terminal 10 in response to a request of the user terminal 10.

The data server 30 can be also configured with a general-purpose computer provided with a CPU (a processor), a memory, an auxiliary memory (such as an HDD), a communication device, and input device, a display device and the like. Various kinds of functions of the data server 30 described later are realized by the CPU executing a program.

Next, details of the user terminal 10 will be described.

The user terminal 10 is a computer, for example, a smartphone, a mobile phone, a tablet computer, a personal information terminal, a personal computer or a wearable computer (such as a smartwatch). The user terminal 10 is configured including a near-field communication unit 11, a controller 12, a storage unit 13, an input/output unit 14 and a communication unit 15.

The near-field communication unit 11 is a unit configured to receive sensor data (a wireless communication interface) from the sensor amplifier 22 via wireless communication. In the present embodiment, the near-field communication unit 11 performs data communication by the Bluetooth standard. The sensor amplifier 22 and the user terminal 10 are paired beforehand and are connected at any time in response to a request.

The controller 12 is an arithmetic device that is in charge of control performed by the user terminal 10. The controller 12 can be realized by an arithmetic processing device such as a CPU (central processing unit).

The controller 12 is configured to be capable of executing two kinds of functions described below.

A first function is a function of receiving sensor data from the sensor amplifier 22 and transmitting the sensor data to the data server 30 via a network.

A second function is a function of acquiring sensor data specified by the user from the data server 30 and outputting the sensor data after visualizing the sensor data.

In the present embodiment, these functions are realized by a web browser operating on the user terminal 10 executing JavaScript. A specific method will be described later.

The storage unit 13 is configured including a main memory and an auxiliary memory. The auxiliary memory is a device in which programs to be executed by the controller 12 and data used by the program are stored. In the auxiliary memory, the programs to be executed by the controller 12 (for example, the web browser), which are packaged as applications, may be stored. Further, an operating system for executing these applications may be stored.

The main memory is a memory where the programs to be executed by the controller 12 and the data used by the programs are developed. By a program stored in the auxiliary memory being loaded onto the main memory and executed by the controller 12, processes hereinafter described are performed. Further, a part of the area the main memory has is assigned to the web browser.

The main memory may include a RAM (random access memory) and a ROM (read-only memory). The auxiliary memory may include an EPROM (erasable programmable ROM) or an HDD (hard disk drive). Furthermore, the auxiliary memory may include a removable medium, that is, a removable recording medium. The removable medium is, for example, a USB (universal serial bus) memory or a disk recording medium like a CD (compact disc) and a DVD (digital versatile disc).

The input/output unit 14 is a unit configured to accept an input operation performed by the user and present information to the user. The input/output unit 14 may be configured with one touch panel display. In other words, the input/output unit 14 may be configured with a liquid crystal display and control unit therefor, and a touch panel and control unit therefor. Further, the input/output unit 14 may be configured with a display and an input device (a keyboard, a mouse and the like).

The communication unit 15 is a communication interface for connecting the user terminal 10 to the network. The communication unit 15 is configured including, for example, a network interface board and a wireless communication circuit for wireless communication. The communication unit 15 may provide access to the network, for example, via a wireless LAN or a mobile communication service such as 3G, LTE.

Next, a configuration of the data server 30 will be described.

The data server 30 is configured including a communication unit 31, a storage unit 32 and a controller 33.

The data server 30 is configured with a general computer. In other words, the data server 30 is a computer having a processor such as a CPU or a GPU, a main memory such as a RAM and a ROM, and an auxiliary memory such as an EPROM, a hard disk drive and a removable medium. Note that the removable medium may foe, for example, a USB flash drive or a disk recording medium like a CD and a DVD. In the auxiliary memory, an operating system (OS), various kinds of programs, various kinds of tables and the like are stored. By loading a program stored in the auxiliary memory to a work area of the main memory and executing the program, and each component unit and the like being controlled through execution of the program, each of functions corresponding to predetermined purposes as described later can be realized. A part or all of the functions may be realized by a hardware circuit such as an ASIC and an FPGA. Note that the data server 30 may be configured with a single computer or may be configured with a plurality of computers that are in mutual cooperation with one another.

The communication unit 31 is a communication interface for connecting the data server 30 to the network.

The storage unit 32 is a device which includes the main memory and the auxiliary memory and in which programs to be executed by the controller 33 and data used by the programs are stored.

Since the communication unit 31 and the storage unit 32 are similar to the communication unit 15 and the storage unit 13, detailed description will be omitted.

In the present embodiment, the storage unit 32 has a database in which sensor data transmitted via the user terminal 10 is accumulated. The database is constructed by a database management system (DBMS) program executed by the processor managing data stored in the auxiliary memory. The database used in the present embodiment is, for example, a relational database.

The controller 33 is an arithmetic device that is in charge of control performed by the data server 30. The controller 33 can be realized by an arithmetic processing device such as a CPU.

In the present embodiment, the controller 33 executes a process of receiving sensor data from the user terminal 10 and causing the sensor data to be stored into the storage unit 32 and a process of extracting sensor data specified by the user from among the stored sensor data and transmitting the sensor data to the user terminal 10. These functions may be realized by executing a program stored in the auxiliary memory by the CPU.

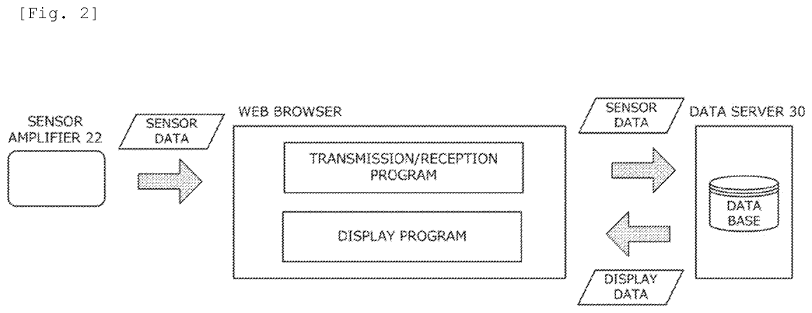

Next, a description will be made on functions that the web browser operating on the user terminal 10 performs, with reference to FIG. 2. FIG. 2 is a diagram illustrating a flow of data handled by the sensor data collection system according to the present embodiment.

The controller 12 that the user terminal 10 has is configured to be capable of executing the web browser by executing a program stored in the storage unit 13. When the user of the user terminal 10 activates the web browser and accesses a predetermined URL (uniform resource locator), a web page giving an instruction to acquire sensor data is provided. This web page may be placed in a local storage (the storage unit 13) or may be placed in the data server 30.

When the user performs an operation of giving an instruction to acquire sensor data, a program written in JavaScript (hereinafter referred to as a transmission/reception program) is called, and the transmission/reception program performs wireless connection to the sensor amplifier 22 via a Web Bluetooth API. Note that, when there are a plurality of sensor amplifiers 22, the user may specify which sensor amplifier 22 is to be connected to. Then, sensor data as illustrated in FIG. 3 is acquired from the connected sensor amplifier 22. Thereby, the acquired sensor data is temporarily stored in the memory area assigned to the web browser.

The sensor data acquired from the sensor amplifier 22 and temporarily stored is transmitted to the data server 30 via the network. The data server 30 stores the received sensor data and stores the sensor data into the database (the storage unit 32).

Next, a description will be made on a process of outputting sensor data by the web browser operating on the user terminal 10 to provide the sensor data to the user.

When the user performs an operation of giving an instruction to display sensor data via the web browser, a program written in JavaScript (hereinafter referred to as a display program) is called, and the display program acquires data for displaying the sensor data (hereinafter referred to as display data) from the data server 30. Note that operations performed by the user may include, in addition to the operation of requesting display of the sensor data, an operation of giving a meaning to the display data. The data acquired here is data extracted based on conditions specified by the user, from among sensor data accumulated in the data server 30. For example, the user can specify which data corresponding to which sensor among the plurality of sensors 21 is to be acquired, a date and time when sensing was performed, or the like. The data server 30 searches for a record in the database based on the conditions specified by the user and transmits relevant data to the user terminal 10 as the display data.

Next, the display program generates a GUI (graphical user interface) to be provided to the user, based on the acquired display data. The GUI may be in any format if measured values of the sensors are visually displayed. For example, a table format or a graph format is possible. Further, when a range of times at which sensing was performed is specified, display may be performed in a format in which changes in time-series values can be visually confirmed.

The processes described above are executed on the web browser by the programs written in a programming language such as JavaScript. Note that the transmission/reception program and the display program may be stored in the user terminal 10 or may be stored in the data server 30. They may be stored in an apparatus connected via the network other than the user terminal 10 and the data server 30.

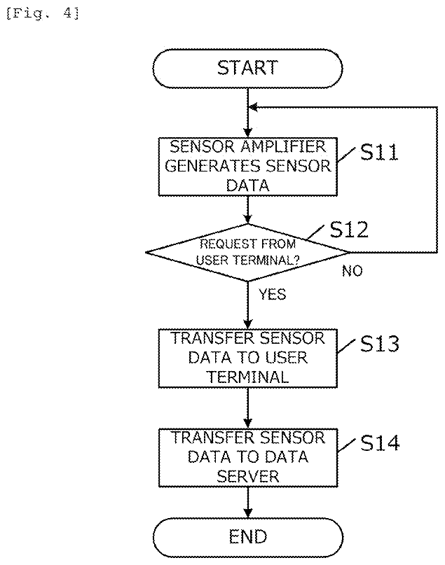

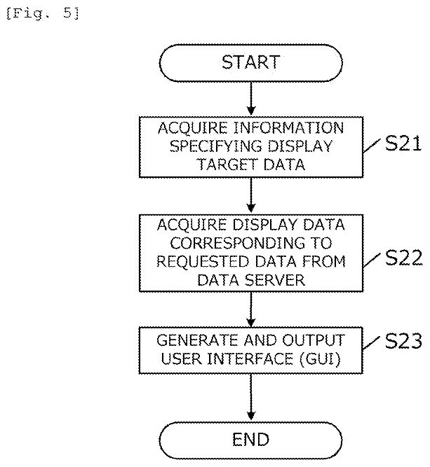

Next, a description will be made on flows of the processes performed by the sensor data collection system according to the present embodiment with reference to FIGS. 4 and 5.

FIG. 4 is a flowchart of the process of the user terminal 10 receiving sensor data outputted by the sensor device 20 and transmitting the sensor data to the data server 30 (the first process).

First, at step S11, the sensor amplifier 22 collects measured values from one or more sensors 21 connected under the sensor amplifier 22 and generates sensor data. The generation of sensor data may be performed every predetermined cycle. The generated sensor data is temporarily stored by the sensor amplifier 22 until a request is given from the user terminal 10.

Next, at step S12, it is judged whether a sensor data transmission request has been issued from the user terminal 10 to the sensor amplifier 22 or not. The sensor data transmission request may be generated based on an operation performed by the user or may be periodically generated. If a transmission request is issued, the process transitions to step S13.

At step S13, the sensor amplifier 22 transmits sensor data to the user terminal 10. As described before, this step is executed by the transmission/reception program (a program written in JavaScript) operating on the web browser calling an API. The transferred sensor data is temporarily stored into the memory area assigned to the web browser.

Next, at step S14, the transmission/reception program transfers the temporarily stored sensor data to the data server 30. The data server 30 stores the received sensor data into the database.

FIG. 5 is a flowchart of the process of the user terminal 10 acquiring display data from the data server 30 and providing the display data to the user (the second process). The illustrated process is executed by the user terminal 10 (the controller 12) when display of the sensor data is triggered.

The process illustrated in FIG. 5 may be started, for example, based on a user operation performed on the web browser, or may be automatically (for example, periodically) started by the user terminal 10.

First, at step S21, information specifying display target data (hereinafter referred to as conditions data) is acquired. At this step, for example, a screen for specifying conditions is presented to the user via the web browser, and information specifying a target sensor, information specifying a date and time when sensing was performed, and the like are acquired from the user. Note that the conditions data acquired here may be automatically generated based on content set beforehand.

Next, at step S22, a display data acquisition request is generated based on the acquired conditions data and transmitted to the data server 30. Then, the data server 30 (the controller 33) generates a data base search query based on the received request and extracts sensor data. The extracted sensor data is transmitted to the user terminal 10 as display data.

Next, at step S23, a GUI to be provided to the user is generated based on the received display data and outputted to the input/output unit 14 (for example, the display).

As described above, in the sensor data collection system according to the present embodiment, the web browser operating on the user terminal 10 acquires sensor data from the sensor device 20 and transfers the sensor data to the data server 30. Further, accumulated sensor data is visualized using the web browser. Thereby, the necessity of constructing a dedicated environment for causing sensor data to be collected and displayed, in the user terminal 10, is eliminated. In other words, since it is possible to cause only connection to a network and operation of a web browser to be mandatory requirements for the user terminal 10, it becomes possible to introduce any computer that is equipped with a web browser function into a system without installing special application software, a device driver and the like, and it is possible to reduce initial cost.

Note that the configuration of the embodiment described above is a mere specific example of the present, invention and is not intended to limit the scope of the present invention. The present invention can take various specific configuration within a range not departing from its technical idea. For example, the data structure and the table structure shown in the above embodiment are mere examples, and items may be appropriately added or exchanged.

Further, though the function of receiving sensor data from the sensor device 20 and transmitting the sensor data to the data server 30 is realized by a program operating on the web browser in the description of the embodiment, acquisition of data from the sensor device 20 and transmission of the data to the data server 30 may be realized by a program other than the program (for example, a native application). In other words, a configuration may be adopted in which only display of data is performed by the web browser.

Further, although a web browser is shown as an example in the description of the embodiment, the web browser may not necessarily be executed as independent application software. For example, it may be called from within a native application as a component.

Further, although a form in which the transmission/reception program and the display program are independent is shown as an example in the description of the embodiment, the transmission/reception program and the display program may mutually hand over data. For example, the transmission/reception program may be configured to transmit received sensor data to the display program so that the sensor data is visualized in real time. Since the transmission/reception program and the display program are executed on the same web browser, data can be handed over by referring to the memory area assigned to the web browser.

Further, although acquisition and display of sensor data in a sensor network is shown as an example in the description of the embodiment, the present invention is applicable to a device network that includes devices other than sensors. In that case, a basic configuration of a system is similar to that of the above embodiment, and “sensor” in the above embodiment can be replaced with “device”, and “sensor data” can be replaced with “data”.

### REFERENCE SIGNS

10: User terminal
11: Near-field communication unit
12, 33: Controller
13, 32: Storage unit
14: Input/output unit
15, 31: Communication unit
20: Sensor device
21: Sensor
22: Sensor amplifier
30: Data server

1. An information processing method, wherein
an information processing apparatus executes:
a reception step of receiving sensor data transmitted from a sensor device via near-field wireless communication;
a transmission step of transmitting the received sensor data to a server apparatus; and
an output step of acquiring sensor data specified by a user from the server apparatus and providing the sensor data to the user; wherein
at the output step, a web browser operating on the information processing apparatus is used as an output interface.

2. The information processing method according to claim 1, wherein
the reception step is executed by an external program operating on the web browser; and
the received sensor data is stored into a memory area assigned to the web browser.

3. The information processing method according to claim 2, wherein
at the transmission step, the sensor data stored in the memory area is transmitted to the server apparatus.

4. The information processing method according to claim 2, wherein
the external program causes the information processing apparatus to receive the sensor data via a wireless communication API that is not dependent on an architecture of the information processing apparatus.

5. The information processing method according to claim 2, wherein
the external program causes the information processing apparatus to receives the sensor data via a Web Bluetooth API.

6. The information processing method according to claim 2, wherein
the external program is stored in the server apparatus.

7. The information processing method according to claim 1, wherein
the information processing apparatus is a mobile terminal.

8. A program executed by a web browser operating on an information processing apparatus, the program executing:
a reception step of receiving sensor data transmitted from a sensor device via near-field wireless communication;
a transmission step of transmitting the received sensor data to a server apparatus; and
an output step of acquiring sensor data specified by a user from the server apparatus and providing the sensor data to the user.

9. The information processing method according to claim 3, wherein
the external program causes the information processing apparatus to receive the sensor data via a wireless communication API that is not dependent on an architecture of the information processing apparatus.

10. The information processing method according to claim 3, wherein
the external program causes the information processing apparatus to receives the sensor data via a Web Bluetooth API.

11. The information processing method according to claim 3, wherein
the external program is stored in the server apparatus.

12. The information processing method according to claim 4, wherein
the external program is stored in the server apparatus.

13. The information processing method according to claim 5, wherein
the external program is stored in the server apparatus.

14. The information processing method according to claim 2, wherein
the information processing apparatus is a. mobile terminal.

15. The information processing method according to claim 3, wherein
the information processing apparatus is a mobile terminal.

16. The information processing method according to claim 4, wherein
the information processing apparatus is a mobile terminal.

17. The information processing method according to claim 5, wherein
the information processing apparatus is a mobile terminal.

18. The information processing method according to claim 6, wherein
the information processing apparatus is a mobile terminal.
